(19) United States
(12) Patent Application Publication
(10) Pub. No.: US 2004/0099025 A1
(43) Pub. Date: May 27, 2004

(54) Anti-theft combination lock for car

(76) Inventor: Chi-Jung Wang, Keelung City (TW)

Correspondence Address: Chi-Jung Wang, 7F., No. 213, Civic Boulevard. Sec. 4, Taipei, 105, TW

(21) Appl. No.: 10/700,115

(22) Filed: Oct. 31, 2003

(30) Foreign Application Priority Data
Nov. 14, 2002 (TW) 091218308

(51) Int. Cl. B60R 25/02

(52) U.S. Cl. 70/209; 70/247

(57) ABSTRACT

An anti-theft combination lock for car includes a main body having a transverse hole, a driving unit located at one side of the main body, a lock rod extended through the transverse hole of the main body, a lock plate fixedly connected at an end to a power output shaft of the driving unit to movably locate at an upper outer side of the transverse hole to normally engage with one of many annular retaining grooves on the lock rod to set the lock in a locked state. A password may be entered via an input interface provided on a top of an outer case of the main body. An internal memory processor determines the correctness of the entered password and actuates the driving unit to turn the lock plate to an unlock position when the entered password is correct.

### FIELD OF THE INVENTION

The present invention relates to an anti-theft combination lock for car, and more particularly to a key-type electronic combination lock for protecting a car against theft.

### BACKGROUND OF THE INVENTION

In addition to the common remote central-controlled lock system, steeling wheel lock and gearshift lock are also widely used by general car owners to protect their cars against theft.

Most general locks have a lock head at where a key may be inserted to open the lock. This type of lock head is usually made of a copper material, which may be easily destructed and opened using an electric tool. The structure of most key-controlled locks may be effortlessly opened using a general unlocking tool with skill. In brief, conventional steeling wheel lock and gearshift lock fail to effectively achieve the anti-theft function.

It is therefore tried by the inventor to develop an anti-theft combination lock for car that is complete, secure, and safe for use to overcome the problems existed in the conventional steering wheel lock and gearshift lock.

### SUMMARY OF THE INVENTION

A primary object of the present invention is to provide an anti-theft combination lock for car, which includes an internal memory processor adapted to determine the correctness of a password entered via a keypad provided on a top of the lock. When a correct password is entered, the memory processor actuates a lock plate to disengage from a lock rod and thereby unlocks the lock, and when the entered password is incorrect, the memory processor actuates an alarm buzzer to emit a high decibel sound. These arrangements make the lock more complete and safer for use.

Another object of the present invention is to provide an anti-theft combination lock for car, which mainly includes a main body having a transverse hole, a driving unit located at one side of the main body, a lock rod extended through the transverse hole of the main body, and a lock plate fixedly connected at an end to a power output shaft of the driving unit to movably locate at an upper outer side of the transverse hole to normally engage with one of many annular retaining grooves on the lock rod to set the lock in a locked state.

A further object of the present invention is to provide an anti-theft combination lock for car, in which contact switches are provided to control a travel of a lock plate between a locking and an unlocking position. Moreover, the combination lock further includes a hold-down plate elastically movably attached to an outer side of the lock plate to ensure secure and firm locking effect of the anti-theft combination lock.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of an anti-theft combination lock for car according to the present invention with an outer case and an input interface removed therefrom;

FIG. 2 is an assembled view of FIG. 1;

FIG. 3 is an assembled perspective view of the anti-theft combination lock for car according to the present invention;

FIG. 4 shows a lock plate of the anti-theft combination lock of the present invention in a standby position;

FIG. 5 shows the lock plate of the anti-theft combination lock of the present invention in an unlock position;

FIG. 6 is a flowchart showing steps included in the operation of the present invention;

FIG. 7 is a perspective view showing the use of the present invention to lock a steering wheel; and

FIG. 8 is a perspective view showing the use of the present invention to lock a gearshift.

### DETAILED DESCRIPTION OF THE PREFERRED EMBODIMENTS

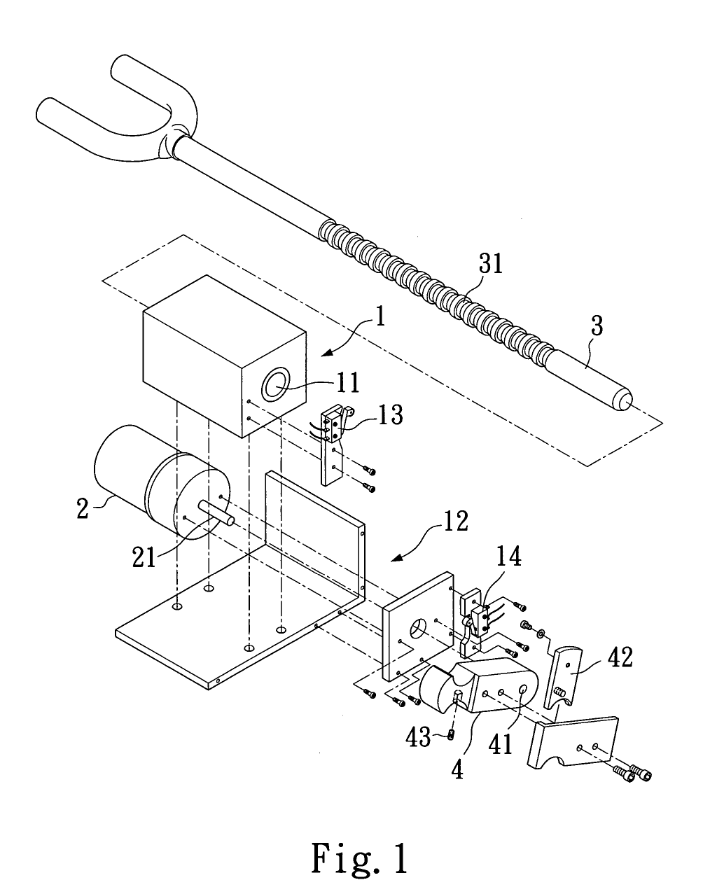

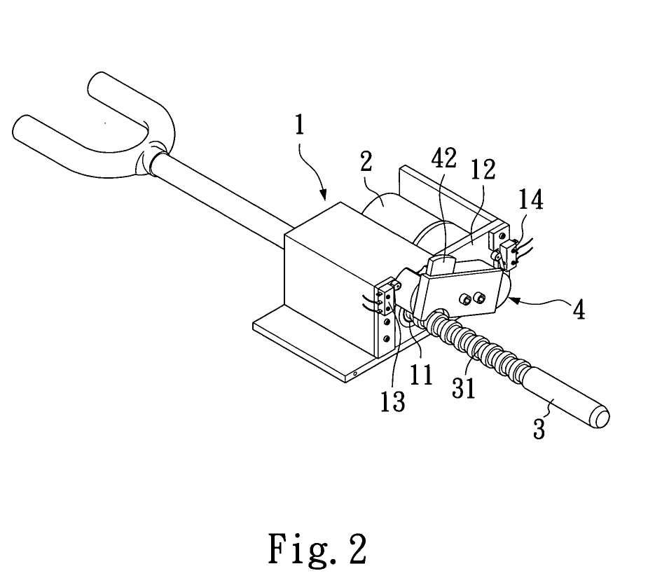

Please refer to FIGS. 1, 2, and 3. The present invention relates to an anti-theft combination lock for car that mainly includes a main body 1, a driving unit 2, a lock rod 3, a lock plate 4, and an input interface 5.

The main body 1 is provided with a transverse through hole 11 for the lock rod 3 to extend therethrough and thereby associate with the main body 1. The main body 1 is mounted on a fixing seat 12, and the driving unit 2 is also mounted on the fixing seat 12 to locate at one side of the main body 1. A first contact switch 13, a second contact switch 14, a battery compartment 15, a memory processor (not shown), and an alarm buzzer (not shown) are provided on the main body 1 at predetermined positions.

The driving unit 2 may be a general brake motor, a servomotor, or a step motor. When the driving unit 2 is screwed to the fixing seat 12, a power output shaft 21 of the driving unit 2 is projected from the fixing seat 12. The driving unit 2 is under control of the memory processor.

The lock rod 3 includes a rod body provided with a plurality of annular retaining grooves 31 and having an outer diameter matching an inner diameter of the through hole 11 on the main body 1.

The lock plate 4 is a flat body having a rear end provided at a predetermined position with a hole 41, through which the power output shaft 21 of the driving unit 2 is extended for the lock plate 4 to turn about the shaft 21. A hold-down plate 42 is movably attached to an outer side of the lock plate 4 opposite to the main body 1, such that a lower edge of the hold-down plate 42 is slightly projected from a lower side of the lock plate 4. A spring 43 embedded in a bottom surface of the lock plate 4 normally pushes the hold-down plate 42 to the downward projected position.

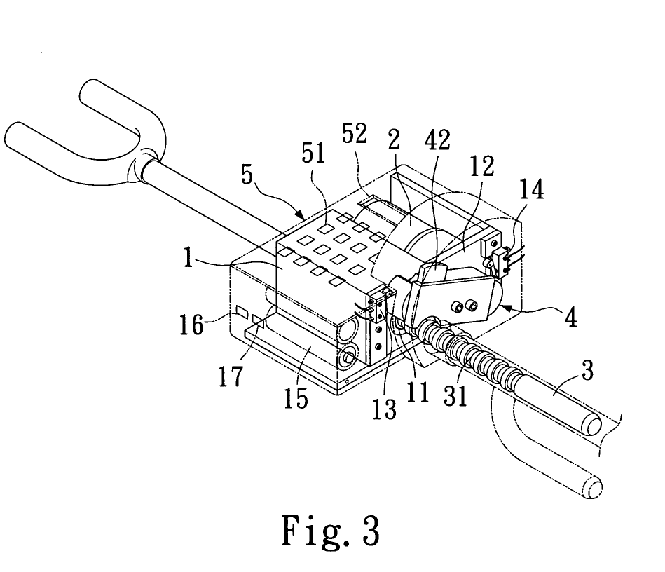

As can be seen from FIG. 3, the input interface 5 includes a keypad 51 and a display 52 located at a top surface of an outer case for the main body 1. The keypad 51 may includes a plurality of membrane keys or general keys, and is electrically connected to the display 52 and the memory processor, so that signals input via the keypad 51 are sent to the display 52 and the memory processor.

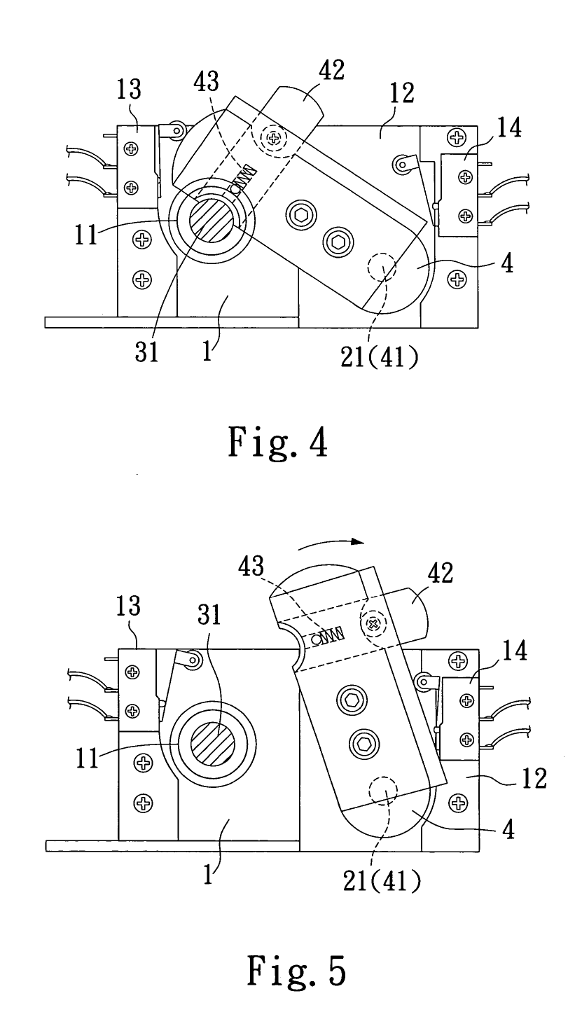

When the lock rod 3 is extended through the transverse through hole 11 on the main body 1, the lock plate 4 engages with any one of the annular retaining grooves 31 on the lock rod 3 to locate at a locking position and produce a locked state, as shown in FIG. 4. When a user wants to release the lock from the locked state, a password must be entered via the input interface 5 provided outside the main body 1. The internal memory processor would determine whether the entered password is correct or not. When the entered password is determined as correct, the driving unit 2 is actuated to turn the lock plate 4 from the locking position to an unlock position to release the lock rod 3 from the locked state, as shown in FIG. 5. Or, when the entered password is determined as incorrect, the alarm buzzer is actuated to buzz.

As can be seen from FIG. 3, the outer case of the main body 1 is also provided at predetermined positions with an AC power jack 16 and a connector 17. In the event batteries provided in the battery compartment 15 are no longer usable, the anti-theft combination lock of the present invention may be connected to an external AC power source or be recharged via the AC power jack 16. The anti-theft combination lock of the present invention may also be connected to an auxiliary input device via the connector 17, so that the lock may still be operated in a suitable handling mode under any conditions, including, for example, insufficient power supply or damaged keypad, without the risk of being unlockable.

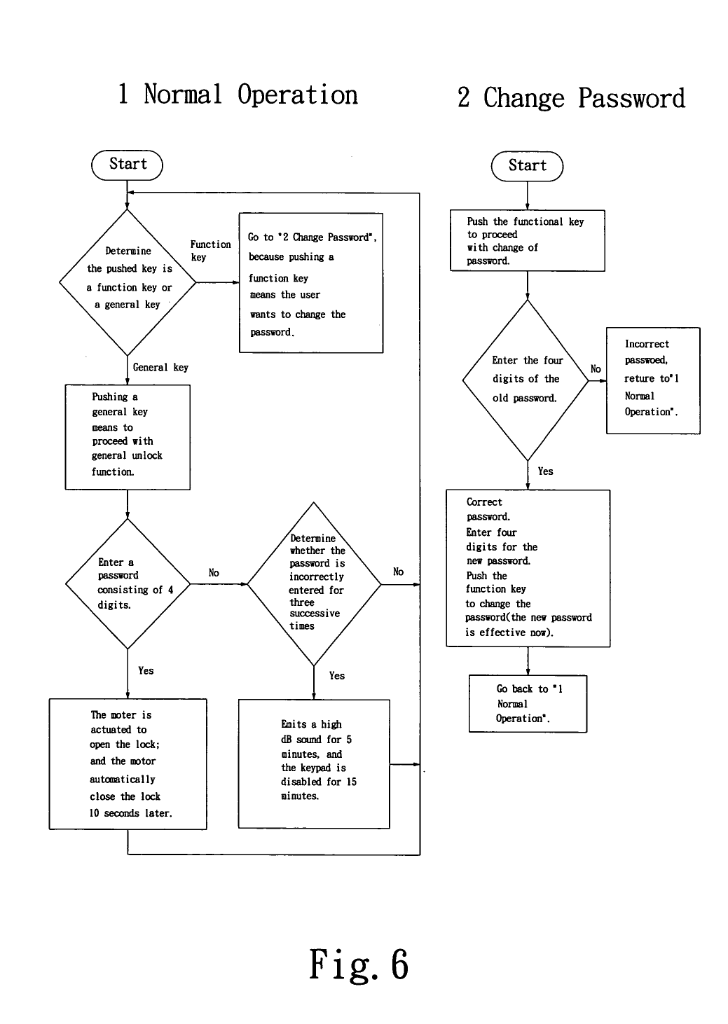

FIG. 6 is a flowchart showing steps included in operating the anti-theft combination lock of the present invention via the input interface 5. The operation of the present invention may be divided into two major parts, namely, normal operation and setting of password.

When the user intends to proceed with the normal operation, the memory processor automatically determines whether a general key is pushed for normal operation or a function key is pushed for setting a password.

When a general key is pushed to start the normal operation for opening the lock, the memory processor would then determine whether a password entered by the user is correct or not. If the entered password is correct, the driving unit 2 is actuated to turn the lock plate 4 from the locking position to the unlock position to release the lock rod 3 from the locked state and thereby open the lock. When a preset number of seconds have lapsed, the driving unit 2 is automatically actuated to turn the lock plate 4 from the unlock position to the locking position again.

When the memory processor determines the entered password is incorrect, the lock is immediately returned to an initial locked state waiting for unlocking operation. In the event incorrect passwords have been successively entered for times exceeded a preset number, the memory processor would then automatically actuate the alarm buzzer to emit a high decibel (dB) sound, and cause the keypad to automatically disable for fifteen minutes.

When a function key is pushed to proceed with the setting of a new password, an old password must be entered first. The memory processor determines whether the entered old password is correct or not. If the entered old password is determined as correct, a new password may be input to replace the old one immediately. If the entered old password is determined as incorrect, the lock is immediately returned to an initial locked state waiting for unlocking operation.

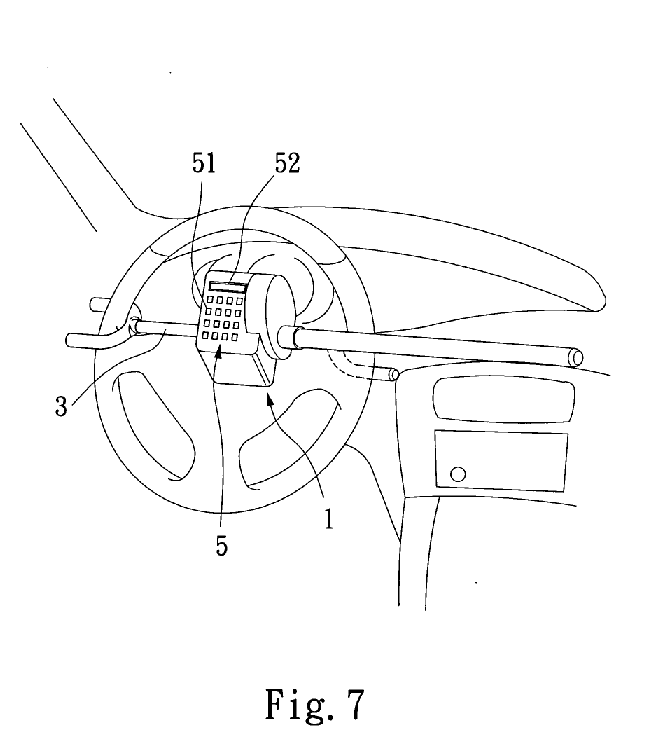

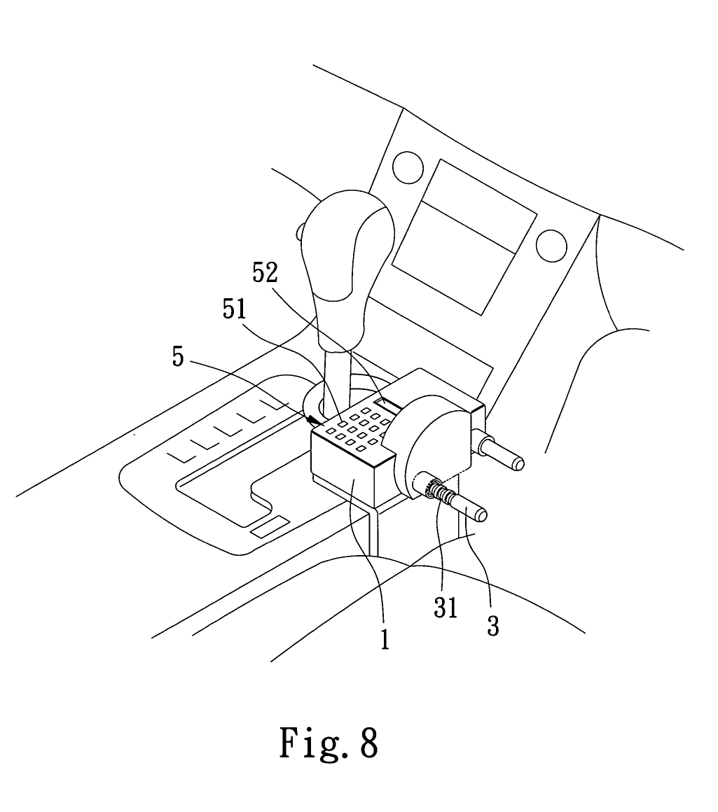

From the above-described structure, it is understood the anti-theft combination lock of the present invention is an all-purpose smart electronic combination lock, and may be implemented in different types, such as a steeling wheel lock as shown in FIG. 7, or a gearshift lock as shown in FIG. 8.

The first and the second contact switch 13, 14 provided at two opposite sides of the main body 1 are used to control a travel of the lock plate 4 from the locking position to the unlock position. Please refer to FIG. 4. When the lock plate 4 is pivotally turned to the locking position, the first contact switch 13 is in contact with a front end of the lock plate 4 to thereby send a contact signal to the driving unit 2 for the latter to stop the lock plate 4 from turning any further, so that the lock plate 4 is accurately located immediately above an outer upper edge of the through hole 11, allowing the hold-down plate 42 to elastically move between the annular retaining grooves 31 of the lock rod 3 when the latter is inserted into the main body 1 via the through hole 11. When a predetermined insertion length is reached, the hold-down plate 42 is allowed to move downward and engage with a corresponding one of the annular retaining grooves 31 to complete the lock operation.

Please refer to FIG. 5. When the lock plate 4 is pivotally turned upward to the unlock position, the second contact switch 14 is in contact with an upper side of the lock plate 4 to thereby send a contact signal to the driving unit 2 for the latter to stop the lock plate 4 from turning any further.

When the driving unit 2 is a servomotor or a step motor that enables control of motor rotations per minute, the travel of the lock plate 4 may be controlled through programming.

What is claimed is:

1. An anti-theft combination lock for car, comprising
a main body, a driving unit, a lock rod, a lock plate, and an input interface;
said main body being provided with a transverse through hole for said lock rod to extend therethrough and thereby associate with said main body; said main body being mounted on a fixing seat, and a battery compartment and a memory processor being provided on said main body at predetermined positions;
said driving unit being mounted on said fixing seat to locate at one side of said main body with a power output shaft of said driving unit projected from said fixing seat; and said driving unit being under control of said memory processor;
said lock rod including a rod body provided with a plurality of annular retaining grooves;
said lock plate being a flat body having a rear end provided at a predetermined position with a hole, through which said power output shaft of said driving unit is extended for said lock plate to fixedly connect to said power output shaft; and
said input interface including a keypad and a display located at a top surface of an outer case for said main body, and said keypad being electrically connected to said memory processor, so that signals input via said keypad are sent to said memory processor;
whereby when said lock rod is extended through said through hole on said main body, said lock plate engages with any one of said annular retaining grooves on said lock rod to locate at a locking position and produce a locked state; and when a user wants to release said lock from said locked state, a password must be entered via said input interface; and when the entered password is determined by said internal memory processor as correct, said driving unit is actuated to turn said lock plate from said locking position to an unlock position to release said lock rod from said locked state.

2. The anti-theft combination lock for car as claimed in claim 1, further comprising a first and a second contact switch provided at predetermined positions on said main body and electrically connected to said driving unit, so that a contact signal may be sent from said first or said second contact switch to said driving unit when said lock plate is in contact with said first or said second contact switch.

3. The anti-theft combination lock for car as claimed in claim 1, wherein said driving unit is selected from the group consisting of general brake motor, servomotor, and step motor.

4. The anti-theft combination lock for car as claimed in claim 1, wherein said rod body of said lock rod has an outer diameter matching an inner diameter of said through hole on said main body.

5. The anti-theft combination lock for car as claimed in claim 1, further comprising a hold-down plate movably attached to an outer side of said lock plate opposite to said main body, and said hold-down plate being normally pushed downward by a spring embedded in a bottom surface of said lock plate.

6. The anti-theft combination lock for car as claimed in claim 5, wherein said hold-down plate has a lower edge slightly projected from a lower side of said lock plate.

7. The anti-theft combination lock for car as claimed in claim 1, wherein said keypad of said input interface is selected from the group consisting of membrane keys and general push buttons.
